(19) United States
(12) Patent Application Publication
(10) Pub. No.: US 2018/0059621 A1
(43) Pub. Date: Mar. 1, 2018

(54) Wearable smart wriststrap or watchband with integrated smartwatch functionality

(71) Applicant: Sanjeev Kumar Singh, Alpharetta, GA (US)

(72) Inventor: Sanjeev Kumar Singh, Alpharetta, GA (US)

(21) Appl. No.: 15/265,435

(22) Filed: Sep. 14, 2016

Related U.S. Application Data
(60) Provisional application No. 62/379,529, filed on Aug. 25, 2016.

(51) Int. Cl. G04B 37/14

(52) U.S. Cl. CPC G04B 37/1486; G04B 47/06

(57) ABSTRACT

A smart wearable wriststrap or watchband transforms a mechanical or a digital wrist timepiece into a smartwatch. The smart wearable wriststrap or watchband comprises a body having a longitudinal length including first and second free ends and a display disposed within the longitudinal length of the body. The body is configured for wearing on a wrist as a strap of a mechanical or a digital wrist timepiece and the first and second free ends of the body are removably attachable to a dial housing of the mechanical or the digital wrist timepiece.

### CROSS REFERENCE TO RELATED APPLICATIONS

This application claims the priority benefit of the co-pending U.S. Provisional Application Ser. No. 62/379,529 entitled “WEARABLE SMART WRISTSTRAP OR WATCHBAND THAT TURNS A CLASSIC WATCH INTO A HYBRID WATCH WITH INTEGRATED SMARTWATCH FUNCTIONALITY,” filed on Aug. 25, 2016, the contents of which are hereby incorporated by reference herein in their entirety.

### BACKGROUND

### 1. Field

Aspects of the present invention relates to a wriststrap or a watchband of a wrist watch or a timepiece, and more particularly, a smart wearable wriststrap or watchband that transforms or converts or turns any regular or classic mechanical or digital timepiece or wrist watch into a hybrid smartwatch.

### 2. Description of the Related Art

Wearable computing has become a prevalent step forward in the progress of technology. Consumers are searching for greater and greater opportunities to integrate technology with everyday wearable items such as glasses, necklaces, and bracelets. Many products on the market today connect to a user's mobile device and allow for the pushing of notifications, answering emails and text messages, as well as the basic functions of keeping time and screening calls.

Mobile, wearables and wellbeing are converging. The data derived from the convergence is starting to enable a new “intimate data economy” analogous to the “digital economy” that sprung up in the mid-1990s. It will enable tackling of 21st century disease. In addition to helping prevent us getting sick over our lifetime it will enable health to be redefined past today's binary sick or not sick model, towards wellness and fitness optimization instead.

An additional trend being seen is the rise of digital fitness trackers. Fitness tracking devices are commonly worn around the wrist, neck, or on the ear, and combine specialized sensors to detect motion, steps taken, and heart rate. More advanced models can combine sensors with computing algorithms to provide a user with respiration rates, calories burned, sleep cycle analyses, and general metabolic information. Many of the fitness trackers currently on the market allow for a user to upload and share fitness data to a computer or a social network, allowing for the tracking of a user's fitness data over time.

A smartwatch refers to a mobile computing device worn on a wrist. In contrast to a mobile device that is carried by hand, such as a smartphone, a smartwatch is designed specifically for being worn on a wrist of the user. A “smartwatch” or similar device typically includes several main components, such as a head unit that includes a processor and a display, a wrist strap that allows a user to wear the smartwatch, and a charger that provides power to the smartwatch, typically when the watch is not being worn by a user.

In spite of the rising popularity of both wearable computers and fitness trackers, the wristwatch still remains a popular fashion accessory. Wristwatches can be a triumph of mechanical design, having hundreds, even thousands, of moving parts. Many luxury watches have the mechanical ability to display far more than the hours and the minutes; extra features, such as tracking eclipses or planetary motions, are termed “complications” in horology, the study of watches and clocks. Timepieces convey status and wealth, fashion and taste, and a sense of punctuality. And while many of the above mentioned wearable computers or fitness trackers seek to emulate clocks or watches on their central displays, none can replicate the mechanical intricacy or aesthetic elegance of a luxury timepiece.

Therefore, a mechanical or digital timepiece overcoming various problems and shortcomings of the prior art would be an important improvement in the art.

### SUMMARY

Briefly described, aspects of the present invention relate to a watchband with integrated electronics and a display that can provide the same functionality of a wearable computer or fitness tracker, but able to be attached to a user's desired mechanical or digital timepiece such that the timepiece's aesthetics and functionality are not impaired. Create your own hybrid smartwatch, enjoying health monitoring and notification features, simply by switching out your existing wrist straps/bands. The smart wriststrap or watchband may be seamlessly paired up with a mobile phone APP. Keep receiving your notifications through the display of this built-in fully-capable and fully-functional integrated smartwatch in a traditional watch via a smart wriststrap or watchband. A smart wearable wriststrap or watchband with its own display built in within a strap/band length in between two timepiece connection channels that receive timepiece joints for holding a standard mechanical or a digital timepiece in place. A smart wearable wriststrap or watchband with a display built in a longitudinal length of the wearable smart wriststrap or watchband and it is designed to be attachable to any traditional mechanical or digital wrist timepieces or wrist watches, adding fitness tracking, notifications and calling features to any standard wrist watch. Any standard mechanical or a digital timepiece can be used with the wearable smart wriststrap or watchband. The wearable smart wriststrap or watchband includes first and second timepiece connection channels on two free ends to receive a corresponding first and second timepiece joints for holding the standard mechanical or a digital timepiece in place by the combination of the first and second timepiece joints and the first and second timepiece connection channels.

The smart wearable wriststrap or watchband performs as a normal watchband with the electronics capability of a mobile computer and a fitness tracker. The smart wearable wriststrap or watchband has an embedded heart rate sensor, body temperature sensor, ambient temperature sensor, vibration generator, inertial sensors, and wireless communication device. The smart wearable wriststrap or watchband is powered by a rechargeable battery, which is recharged using a charging port that can be connected to a battery charger. As smartwatches take hold, many horological hardliners are sticking to their traditional watches with renewed fervour. So a smart wearable wriststrap or watchband that gives classic timepieces a smart upgrade by turning them into a hybrid timepiece with two traditional and smart types of watches into one could be just what the traditionalist has been waiting for. It's the complete smart watch with its own display built in the wriststrap or watchband that makes this smart wriststrap or watchband truly unique. You can use it for taking calls or to have it read out your text messages. The smart wriststrap or watchband has links at the ends that can be added or removed to get a better fit. The smart wearable wriststrap or watchband works with Android and iOS.

In accordance with one illustrative embodiment of the present invention, a smart wearable watchband is provided. The smart wearable watchband comprises a body having a longitudinal length including first and second free ends and a display disposed within the longitudinal length of the body. The body is configured for wearing on a wrist as a strap of a mechanical or a digital wrist timepiece and the first and second free ends of the body are removably attachable to a dial housing of the mechanical or the digital wrist timepiece.

Consistent with another embodiment, a modular smart wearable watchband is provided. The modular smart wearable watchband comprises a first smart link having a first longitudinal length including first and second free ends, wherein the first smart link including a first connector on the first free end and a first port on the second free end and wherein the first smart link including a first embedded electronic device. The modular smart wearable watchband further comprises a second smart link having a second longitudinal length including first and second free ends, wherein the second smart link including a second connector on the first free end and a second port on the second free end and wherein the second smart link including a second embedded electronic device different than the first embedded electronic device. The modular smart wearable watchband further comprises a display disposed on the first smart link, wherein the first smart link and the second smart link are together configured for wearing on a wrist as a strap of a mechanical or a digital wrist timepiece and the first free end of the first smart link and the second free end of the second smart link are removably attachable to a dial housing of the mechanical or the digital wrist timepiece.

According to yet another embodiment of the present invention, a method of transforming a mechanical or a digital wrist timepiece into a smartwatch is provided. The method comprises providing a smart wearable watchband including a body having a longitudinal length including first and second free ends, providing a display disposed within the longitudinal length of the body, wherein the body is configured for wearing on a wrist as a strap of a mechanical or a digital wrist timepiece and the first and second free ends of the body are removably attachable to a dial housing of the mechanical or the digital wrist timepiece and converting the mechanical or the digital wrist timepiece into a hybrid watch by attaching the smart wearable watchband to the dial housing of the mechanical or the digital wrist timepiece.

### BRIEF DESCRIPTION OF THE DRAWINGS

FIG. 1 illustrates a perspective view of a smart wearable wriststrap or watchband that transforms or converts or turns any regular or classic mechanical or digital timepiece or wrist watch into a hybrid smartwatch in accordance with an exemplary embodiment of the present invention.

FIG. 2 illustrates a schematic block diagram of the smart wearable wriststrap or watchband of FIG. 1 in accordance with an exemplary embodiment of the present invention.

FIG. 3 illustrates a perspective view of a modular smart wearable wriststrap or watchband according to one embodiment of the present invention.

FIG. 4 illustrates a perspective view of first and second smart links of the modular smart wearable wriststrap or watchband of FIG. 3 according to one embodiment of the present invention.

FIG. 5 illustrates a schematic block diagram of the first and second smart links of the modular smart wearable wriststrap or watchband of FIG. 3 according to one embodiment of the present invention.

FIG. 6 illustrates a perspective view of a smart link of the modular smart wearable wriststrap or watchband of FIG. 3 according to one embodiment of the present invention.

FIG. 7 illustrates a flow chart of a method of transforming a mechanical or a digital wrist timepiece into a smartwatch according to one embodiment of the present invention.

### DETAILED DESCRIPTION

To facilitate an understanding of embodiments, principles, and features of the present invention, they are explained hereinafter with reference to implementation in illustrative embodiments. In particular, they are described in the context of a smart wearable wriststrap or watchband that transforms or converts or turns any regular or classic mechanical or digital timepiece or wrist watch into a hybrid smartwatch. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

Embodiments of the present invention relate to a smart wearable wriststrap or watchband and a modular smart wearable wriststrap or watchband in which smart links or blocks can be selectively added or removed to add or remove smartwatch functionality including health and fitness sensor capabilities. Although some embodiments of this invention may be described and illustrated herein in terms of a single body or a modular body smart wearable wriststrap or watchband, it should be understood that embodiments of this invention are not so limited, but are generally applicable to any smart wearable wriststrap or watchband such as a single length, two-ended traditional flexible or rigid or metal or leather or synthetic material bands and straps. Further, although some embodiments of this invention may be described and illustrated herein in the context of bands and straps, it should be understood that embodiments of this invention are not so limited, but are generally applicable to any timepiece or watch wearable mechanisms, such as jewellery arrangements and assemblies including bracelets and chains.

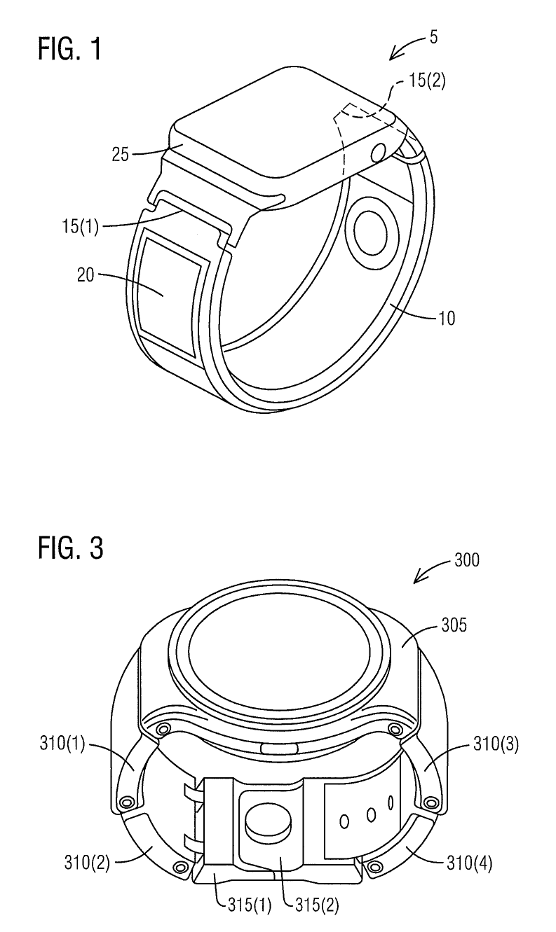

FIG. 1 illustrates a perspective view of a smart wearable wriststrap or watchband 5 that transforms or converts or turns any regular or classic mechanical or digital timepiece or wrist watch into a hybrid smartwatch in accordance with an exemplary embodiment of the present invention. A hybrid smartwatch refers to a mobile computing device worn on a wrist. In contrast to a mobile device that is carried by hand, such as a smartphone, a hybrid smartwatch is designed specifically for being worn on a wrist of the user. A hybrid smartwatch may be worn around the wrist with the smart wearable wriststrap or watchband 5 that combines specialized sensors to detect motion, steps taken, and heart rate with any regular or classic mechanical or digital timepiece or wrist watch. More advanced models of the smart wearable wriststrap or watchband 5 may combine sensors with computing algorithms to provide a user with respiration rates, calories burned, sleep cycle analyses, and general metabolic information. The smart wearable wriststrap or watchband 5 may enable a user to upload and share fitness data to a computer or a social network, allowing for the tracking of a user's fitness data over time.

The smart wearable wriststrap or watchband 5 comprises a body 10 having a longitudinal length including first and second free ends 15(1-2). The smart wearable wriststrap or watchband 5 includes a display 20 disposed within the longitudinal length of the body 10. The body 10 may be configured for wearing on a wrist as a strap of a mechanical or a digital wrist timepiece. The first and second free ends 15(1-2) of the body 10 may be removably attachable to a dial housing 25 of a mechanical or a digital wrist timepiece.

The smart wearable wriststrap or watchband 5 may be made of polycarbonate or stainless steel. The display 20 may be 1.39″ AMOLED display. The display 20 may be 400×400 display. The display 20 may be touch-sensitive display.

The smart wearable wriststrap or watchband 5 may include a bus that connects components such as a processor, a memory, a battery, and one or more sensors. The smart wearable wriststrap or watchband 5 may communicate with a mobile phone via a wired and/or wireless communication component. Power may be provided by a battery, which may be charged by a battery charger. The smart wearable wriststrap or watchband 5 may include a vibrational component or other similar component. Such a feature may be useful, for example, as an alarm. In some configurations, the smart wearable wriststrap or watchband 5 as disclosed herein may be used in conjunction with other computing devices, such as a smart phone, a tablet computing device, and the like. For example, an application executing on the other computing device may be operated in conjunction with an application executing on the smart wearable wriststrap or watchband 5, or it may receive data from the smart wearable wriststrap or watchband 5. Different wristbands may include different sensors or different types of sensors, to allow for customization to specific use cases.

When a mobile phone and the smart wearable wriststrap or watchband 5 are connected, the two may communicate via a wired communication, such as by way of an electrical connector that connects the mobile phone and the smart wearable wriststrap or watchband 5, and/or via a wireless connection such as WiFi, Bluetooth(R), an RFID or near-field communication (NFC) connection, or any other suitable communication technique. Thus, when the two components are connected, the smart wearable wriststrap or watchband 5 may “sync” with the mobile phone by providing data stored in the smart wearable wriststrap or watchband 5 to the mobile phone, as will be readily understood by one of skill in the art. The smart wearable wriststrap or watchband 5 as disclosed herein may include biometric sensors such as heart rate, blood pressure, or the like, which can collect data regardless of whether the smart wearable wriststrap or watchband 5 is connected to the mobile device. When reconnected, the smart wearable wriststrap or watchband 5 may then provide collected data to the mobile device for additional processing and/or analysis.

The smart wearable wriststrap or watchband 5 may have a watch lug 18-24 mm. The smart wearable wriststrap or watchband 5 may sensors: an accelerometer, a gyroscope, a microphone, and a battery: 7 days stand-by and 4 hours talk-time. The smart wearable wriststrap or watchband 5 may have compatibility: iOS 8 or newer, Android 4.4 or newer. The smart wearable wriststrap or watchband 5 may have a charge port as a micro-USB and connectivity Bluetooth/BLE.

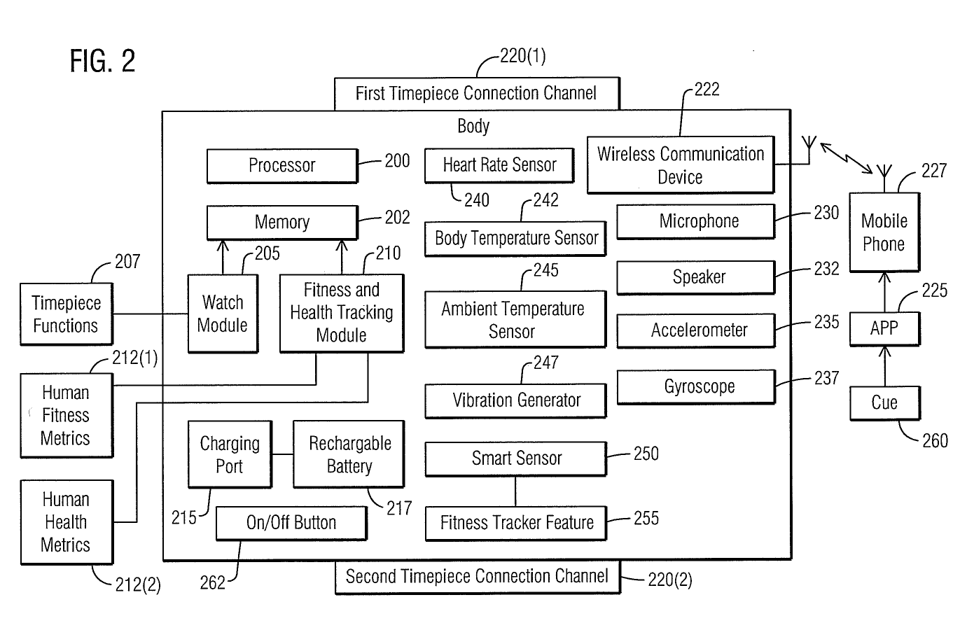

Referring to FIG. 2, it illustrates a schematic block diagram of the smart wearable wriststrap or watchband 5 of FIG. 1 in accordance with an exemplary embodiment of the present invention. The smart wearable wriststrap or watchband 5 further comprises a processor 200 and a memory 202 coupled to the processor 200. For example, in one embodiment, the processor 200 may be Qualcomm Snapdragon 2100 Wear and the memory 202 may be a 512 MB RAM and 4GB flash. The smart wearable wriststrap or watchband 5 further comprises an operating system stored in the memory 202 such as Android Marshmallow.

The memory 202 may store a watch module 205 capable of performing timepiece functions 207 and a fitness and health tracking module 210 to monitor at least one of one or more human fitness metrics 212(1) and one or more human health metrics 212(2). The processor 200 may execute software or firmware instructions of the watch module 205 and the fitness and health tracking module 210. Examples of the human fitness metrics 212(1) includes motion, steps taken, standing, calorie goals, respiration rates, calories burned and sleep cycle analyses. Examples of the human health metrics 212(2) include a heart rate monitoring, a pulse monitoring and general metabolic information.

The smart wearable wriststrap or watchband 5 further comprises a charging port 215 and a rechargeable battery 217 configured to be recharged using the charging port 215 when connected to a battery charger (not shown). The rechargeable battery 217 may be a 300 mAh battery.

In one embodiment, the processor 200, the memory 202, the rechargeable battery 217 are embedded within the body 10. The first free end of the body 10 including a first timepiece connection channel 220(1) and the second free end including a second timepiece connection channel 220(2). The first timepiece connection channel 220(1) is configured to receive a first timepiece joint and the second timepiece connection channel 220(2) is configured to receive a second timepiece joint for holding the mechanical or the digital wrist timepiece in place.

The smart wearable wriststrap or watchband 5 further comprises a wireless communication device 222 configured for seamlessly pairing up with a mobile phone application (APP) 225. For example, a mobile phone 227 of a user may have a watch or timepiece APP installed to work with the smart wearable wriststrap or watchband 5. The wireless communication device 222 may be a Bluetooth module and/or Wi-Fi module capable of wirelessly communicating with the mobile phone APP 225. For example, Wi-Fi 802.11 b/g/n and Bluetooth 4.1 (BLE) may be used.

A user can control, program the smart wearable wriststrap or watchband 5 via the mobile phone APP 225. The wireless communication device 222 may transfer data associated with the timepiece functions 207, the human fitness metrics 212(1) and the human health metrics 212(2) to the mobile phone APP 225.

The smart wearable wriststrap or watchband 5 further comprises a microphone 230, a speaker 232, an accelerometer 235, a gyroscope 237, an embedded heart rate sensor 240, a body temperature sensor 242, an ambient temperature sensor 245 and/or a vibration generator 247. The smart wearable wriststrap or watchband 5 further comprises a smart sensor 250 associated with a fitness tracker feature 255 that instead to tracking alone in real-time the human fitness metrics 212(1) and/or the human health metrics 212(2) periodically via audio or visually alarms or reminds in a form of a cue 260 a user how well at least one of standing, moving, steps and calorie goals are being meet at an ongoing milestone basis. For example, a variety of audio or visually alarms or reminds may be programed via a combination of the fitness tracker feature 255 and the mobile phone APP 225.

The smart sensor 250 tracks your steps, distance, calories burned and active minutes. A user may set their goals and track their progress on the mobile phone APP 225. In an urgent situation, tap a bottom on the smart wearable wriststrap or watchband 5 to notify your emergency contacts with a text message and your GPS location. The smart sensor 250 provides gentle vibrations to notify you to check your phone for important calls, texts and reminders. The smart wearable wriststrap or watchband 5 further comprises an ON/OFF button 262.

The smart sensor 250 is for those of us who spend too long sitting down and are increasing our risk of obesity, heart disease and diabetes. It identifies sitting posture, standing, walking, running and exercise and then hooks up to the mobile device APP 225 which acts as the cue 260 as to how you have been doing every 30 minutes or so over a course of a whole day—and plays playful audio tones. The fitness tracker feature 255 of the smart sensor 250 instead to tracking alone periodically in real-time via audio/visually alarms or reminds us during a normal day to tell us when we are not on track to reach our standing, moving, steps or calorie goals of a day.

For steps if the goal is 12,000 steps in a day then every hour the cue 260 may alarm a user of the mobile phone 227 whether 1,000 step goal of that particular hour is being met or not via a red visual if not met or a green visual if met. Alternatively, soft or curt audio tones may be respectively given out by the cue 260 depending upon if a goal is met or not. One of them or a combination of visuals, tones, vibrations etc. may be used for the cue 260.

Turning now to FIG. 3, it illustrates a perspective view of a modular smart wearable wriststrap or watchband 300 according to one embodiment of the present invention. The modular smart wearable wriststrap or watchband 300 is removably attachable to a dial housing 305 of a mechanical or a digital wrist timepiece. The modular smart wearable wriststrap or watchband 300 is configured for wearing on a wrist as a strap of the mechanical or the digital wrist timepiece. The modular smart wearable wriststrap or watchband 300 includes a plurality of smart blocks or links 310(1-4) and first and second end links 315(1-2). The plurality of smart blocks or links 310(1-4) lets you choose the features and designs that best suit your lifestyle and needs. A user can selectively add functionality. The plurality of smart blocks or links 310(1-4) may be made of polycarbonate or stainless steel. A smart module or block or link 310 may have following dimensions in one embodiment. The length being 25.33 mm, the width being 30.8 mm and the thickness being 7.95 mm.

The modular smart wearable wriststrap or watchband 300 is a fully featured smartwatch with smartphone notifications, activity tracking, voice control and a whole range of apps. You can wear as a normal watch with a strap by itself and add links 310 or modules when you need extra. Each link 310 or module has its own special feature. Only choose the ones that you need and make your own unique device. One link 310 or module may be a display module with a screen. The variety of modules available will only continue to grow. By using the links 310 or modules a use can customize technology around their own needs. Add new features or upgrade your existing ones to infinitely expand the functionality of your modular smart wearable wriststrap or watchband 300.

Examples of the smart links 310 include a flashlight module, an extra battery module, a GPS module, an adventure module, a programmable button module, and a heart rate module. The flashlight module is a white LED Light that you can turn on and off. A strength control can dim the light or vice versa. The flashlight module can provide beam angle, dispersion and range metrics for those who require more information. The extra battery module is designed to extend the battery life of your watch and charge it even when the watch is turned off. While using the extra battery module it will be providing the mAh remaining as well as the charge remaining in the battery. The GPS module provides with accurate positioning and a minimal acquisition time. It uses GPS and GLONASS to provide the best location data possible. The GPS module provides longitude and latitude data as well as location data and accompanying accuracies. The Adventure module is a 3-in-1 sensor which combines digital humidity, pressure and temperature sensors in one. This low power sensor provides the environmental temperature, pressure, altitude and humidity. Perfect for people who love to go exploring and want to track different aspects of their route. The programmable button module can be assigned to anything, whether it be a function on your watch, phone, or other connected devices. One touch, and you are good to go! The heart rate monitor module monitors your pulse rate and receives real-time data to track your wellbeing. Take readings in short intervals to track your heart rate throughout the day.

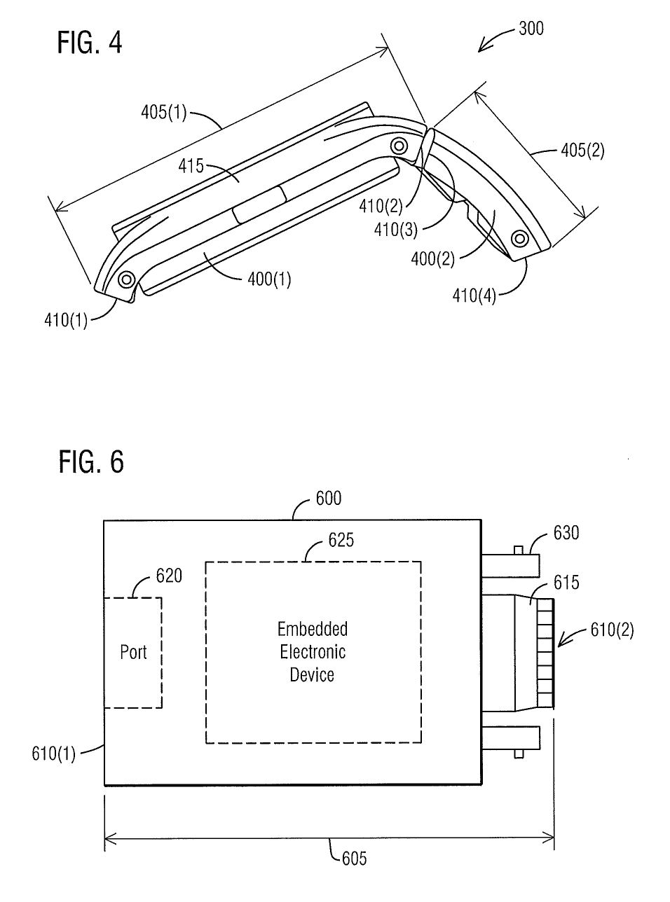

FIG. 4 illustrates a perspective view of first and second smart links 400(1-2) of the modular smart wearable wriststrap or watchband 300 of FIG. 3 according to one embodiment of the present invention. The first smart link 400(1) has a first longitudinal length 405(1) including first and second free ends 410(1-2). The first smart link 400(1) includes a first connector (not shown) on the first free end 410(1) and a first port (not shown) on the second free end 410(2). The first smart link 400(1) includes a first embedded electronic device (not shown). The second smart link 400(2) has a second longitudinal length 405(2) including first and second free ends 410(3-4). The second smart link 400(2) includes a second connector (not shown) on the first free end 410(3) and a second port (not shown) on the second free end 410(4). The second smart link 400(2) includes a second embedded electronic device (not shown) different than the first embedded electronic device. A display 415 is disposed on the first smart link 400(1). The first smart link 400(1) and the second smart link 400(2) are together configured for wearing on a wrist as a strap of a mechanical or a digital wrist timepiece and the first free end 410(1) of the first smart link 400(1) and the second free end 410(4) of the second smart link 400(2) are removably attachable to a dial housing of the mechanical or the digital wrist timepiece.

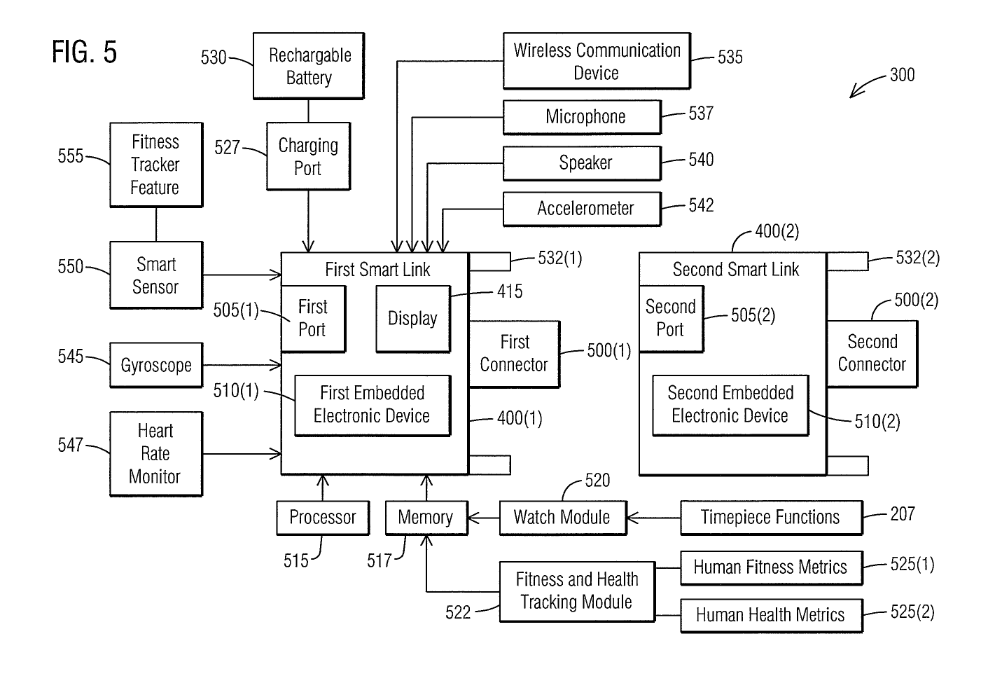

As seen in FIG. 5, it illustrates a schematic block diagram of the first and second smart links 400(1-2) of the modular smart wearable wriststrap or watchband 300 of FIG. 3 according to one embodiment of the present invention. The first smart link 400(1) includes a first connector 500(1) on the first free end 410(1) and a first port 505(1) on the second free end 410(2). The first smart link 400(1) includes a first embedded electronic device 510(1). The second smart link 400(2) includes a second connector 500(2) on the first free end 410(3) and a second port 505(2) on the second free end 410(4). The second smart link 400(2) includes a second embedded electronic device 510(2) different than the first embedded electronic device 510(1). The display 415 is disposed on the first smart link 400(1).

The first smart link 400(1) further comprises a processor 515 and a memory 517 coupled to the processor 515. The memory 517 stores a watch module 520 capable of performing timepiece functions and a fitness and health tracking module 522 to monitor one or more human fitness metrics 525(1) and/or one or more human health metrics 525(2). The first smart link 400(1) further comprises a charging port 527 and a rechargeable battery 530 configured to be recharged using the charging port 527 when connected to a battery charger (not shown). The processor 515, the memory 517, the rechargeable battery 530 may be embedded within a body of the first smart link 400(1).

The first free end 410(1) of the first smart link 400(1) includes a first timepiece connection channel 532(1) and the first free end 410(3) of the second smart link 400(2) includes a second timepiece connection channel 532(2). The first timepiece connection channel 532(1) is configured to receive a first timepiece joint and the second timepiece connection channel 532(2) is configured to receive a second timepiece joint for holding the mechanical or the digital wrist timepiece in place.

The first smart link 400(1) further comprises a wireless communication device 535 configured for seamlessly pairing up with a mobile phone application (APP) such as the mobile device APP 225. The first smart link 400(1) further comprises a microphone 537, a speaker 540, an accelerometer 542, a gyroscope 545 and an embedded heart rate sensor 547. The first smart link 400(1) further comprises a smart sensor 550 associated with a fitness tracker feature 555 that instead to tracking alone in real-time one or more human fitness metrics 525(1) and/or one or more human health metrics 525(2) periodically via audio or visually alarms or reminds a user how well at least one of standing, moving, steps and calorie goals are being meet at an ongoing milestone basis.

As shown in FIG. 6, it illustrates a perspective view of a smart link 600 of the modular smart wearable wriststrap or watchband 300 of FIG. 3 according to one embodiment of the present invention. The smart link 600 has a first longitudinal length 605 including first and second free ends 610(1-2). The smart link 600 includes a connector 615 on the first free end 610(1) and a port 620 on the second free end 610(2). The connector 615 includes a plurality of metal pads for connecting to a port of a next smart link in a chain. One of the metal pads provides power to the smart link 600 from a main/mother smart link (such as the first smart link 400(1)) having a rechargeable battery. The smart link 600 includes an embedded electronic device 625. The first free end 610(1) of the smart link 600 includes a timepiece connection channel 630.

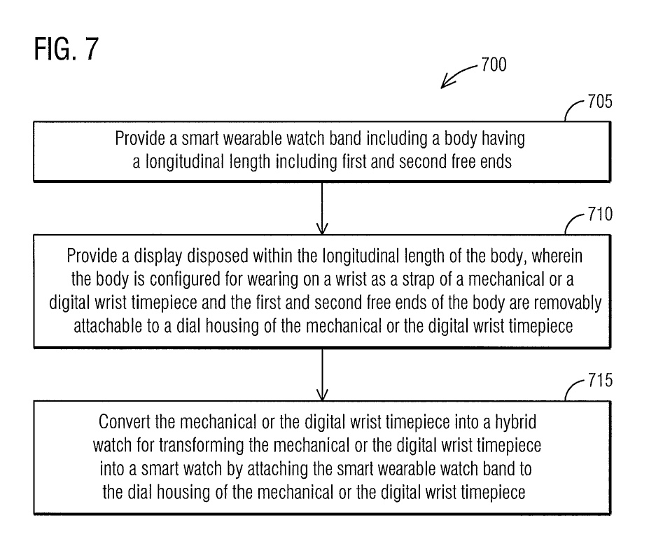

In FIG. 7, it illustrates a flow chart of a method 700 of transforming a mechanical or a digital wrist timepiece into a smartwatch according to one embodiment of the present invention. Reference is made to the elements and features described in FIGS. 1-6. It should be appreciated that some steps are not required to be performed in any particular order, and that some steps are optional.

In step 705, the method 700 includes providing the smart wearable wriststrap or watchband 5 including the body 5 having a longitudinal length including first and second free ends. In step 710, the method 700 includes providing the display 20 disposed within the longitudinal length of the body 10. The body 10 is configured for wearing on a wrist as a strap of a mechanical or a digital wrist timepiece and the first and second free ends of the body 10 are removably attachable to the dial housing 25 of the mechanical or the digital wrist timepiece. In step 715, the method 700 includes converting the mechanical or the digital wrist timepiece into a hybrid watch by attaching the smart wearable wriststrap or watchband 5 to the dial housing 25 of the mechanical or the digital wrist timepiece.

The method 700 further comprises providing the body 10 of the smart wearable wriststrap or watchband 5 as the first smart link 400(1) having a first longitudinal length including first and second free ends. The first smart link 400(1) includes a first connector on the first free end and a first port on the second free end. The first smart link 400(1) includes a first embedded electronic device. The method 700 further comprises providing the body 10 of the smart wearable wriststrap or watchband 5 as the second smart link 400(2) having a second longitudinal length including first and second free ends. The second smart link 400(2) includes a second connector on the first free end and a second port on the second free end. The second smart link 400(2) includes a second embedded electronic device different than the first embedded electronic device. The method 700 further comprises providing the smart sensor 250 associated with the fitness tracker feature 255 in the first smart link 400(1) that instead to tracking alone in real-time at least one of one or more human fitness metrics and one or more human health metrics periodically via audio or visually alarms or reminds a user how well at least one of standing, moving, steps and calorie goals are being meet at an ongoing milestone basis.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Although the steps, operations, or computations may be presented in a specific order, this order may be changed in different embodiments. In some embodiments, to the extent multiple steps are shown as sequential in this specification, some combination of such steps in alternative embodiments may be performed at the same time.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

1.-10. (canceled)

11. A modular smart wearable watchband comprising:
a first smart link having a first longitudinal length including first and second free ends, wherein the first smart link including a first connector on the first free end and a first port on the second free end and wherein the first smart link including a first embedded electronic device, wherein the first smart link includes a rechargeable battery,
a second smart link having a second longitudinal length including first and second free ends, wherein the second smart link including a second connector on the first free end and a second port on the second free end and wherein the second smart link including a second embedded electronic device different than the first embedded electronic device; and
a digital display disposed on the first smart link, wherein the first smart link md the second smart link are together configured for wearing on a wrist as a strap of a mechanical or a digital wrist timepiece and the first free end of the first smart link and the second free end of the second smart link are removably attachable to a dial housing of the mechanical or the digital wrist timepiece,
wherein the first smart link and the second smart link are configured to convert the mechanical or the digital wrist timepiece into a hybrid watch by attaching the modular smart wearable watchband to the dial housing of the mechanical or the digital wrist timepiece such that the first connector of the first smart link is configured for connecting to the second port of the second smart link to form a chain in that the first smart link provides power to the second smart link from the rechargeable battery of the first smart link being a main or mother smart link.

12. The modular smart wearable watchband of claim 11, wherein the first smart link further comprising:
a processor; and
a memory coupled to the processor, the memory storing a watch module capable of performing timepiece functions and a fitness and health tracking models to monitor at least one of one or more human fitness metrics and one or more human health metrics.

13. The modular smart wearable watchband of claim 12, wherein the first smart link further comprising:
a charging port; and
a rechargeable battery configured to be recharged using the charging port when connected to a battery charger.

14. The modular smart wearable watchband of claim 13, wherein the processor, the memory, the rechargeable battery are disposed within a body of the first smart link.

15. The modular smart wearable watchband of claim 11, wherein the first free end of the first smart link including a first timepiece connection channel and the first free end of the second smart link including a second timepiece connection channel, wherein the first timepiece connection channel is configured to receive a first timepiece joint and the second timepiece connection channel is configured to receive a second timepiece joint for holding the mechanical or the digital wrist timepiece in place.

16. The modular smart wearable watchband of claim 11, wherein the first smart link further comprising:
a wireless communication device configured for seamlessly pairing up with a mobile phone application (APP);
a microphone;
a speaker;
an accelerometer;
a gyroscope; and
an embedded heart rate sensor.

17. The modular smart wearable watchband of claim 11, wherein the first smart link further comprising:
a smart sensor associated with a fitness tracker feature.

18.-20. (canceled)

21. The modular smart wearable watchband of claim 16, wherein the first smart link further comprising:
a body temperature sensor;
an ambient temperature sensor; and
a vibration generator.

22. A method of transforming a mechanical or a digital wrist timepiece into a smartwatch, the method comprising:
providing a modular smart wearable watchband including a first smart link having a first longitudinal length including first and second free ends, wherein the first smart link including a first connector on the first free end and a first port on the second free end and wherein the first smart link including a first embedded electronic device, wherein the first smart link includes a rechargeable battery;
providing the modular smart wearable watchband including a second smart link having a second longitudinal length including first and second free ends, wherein the second smart link including a second connector on the first free end and a second port on the second free end and wherein the second smart link including a second embedded electronic device different than the first embedded electronic device; and
providing the modular smart wearable watchband including a digital display disposed on the first smart link, wherein the first smart link and the second smart link are together configured for wearing on a wrist as a strap of a mechanical or a digital wrist timepiece and the first free end of the first smart link and the second free end of the second smart link are removably attachable to a dial housing of the mechanical or the digital wrist timepiece,
wherein the first smart link and the second smart link are configured to convert the mechanical or the digital wrist timepiece into a hybrid watch by attaching the modular smart wearable watchband to the dial housing of the mechanical or the digital wrist timepiece such that the first connector of the first smart link is configured for connecting to the second port of the second smart link to form a chain in that the first smart link provides power to the second smart link from the rechargeable battery of the first smart link being a main or mother smart link.

23. The method of claim 22, wherein the first smart link further comprising:
a processor; and
a memory coupled to the processor, the memory storing a watch module capable of performing timepiece functions and a fitness and health tracking module to monitor at least one of one or more human fitness metrics and one or more human health metrics.

24. The method of claim 23, wherein the first smart link further comprising:
a charging port; and
a rechargeable battery configured to be recharged using the charging port when connected to a battery charger.

25. The method of claim 24, wherein the processor, the memory, the rechargeable battery are disposed within a body of the first smart link.

26. The method of claim 22, wherein the first free end of the first smart link including a first timepiece connection channel and the first free end of the second smart link including a second timepiece connection channel, wherein the first timepiece connection channel is configured to receive a first timepiece joint and the second timepiece connection channel is configured to receive a second timepiece joint for holding the mechanical or the digital wrist timepiece in place.

27. The method of claim 22, wherein the first smart link further comprising:
a wireless communication device configured for seamlessly pairing up with a mobile phone application (APP);
a microphone;
a speaker;
an accelerometer;
a gyroscope; and
an embedded heart rate sensor.

28. The method of claim 22, wherein the first smart link further comprising:
a smart sensor associated with a fitness tracker feature.

29. The method of claim 28, wherein the first smart link further comprising:
a body temperature sensor;
an ambient temperature sensor; and
a vibration generator.
